(19) United States
(12) Patent Application Publication
(10) Pub. No.: US 2019/0295008 A1
(43) Pub. Date: Sep. 26, 2019

(54) System and Method for Continuous Pick Route Optimization

(71) Applicant: Walmart Apollo, LLC, Bentonville, AR (US)

(72) Inventors: Amit Kumar Pundir, Bengaluru (IN); Swapnil Patil, Bengaluru (IN); Ayushi Jain, Mathura (IN)

(21) Appl. No.: 16/037,320

(22) Filed: Jul. 17, 2018

(30) Foreign Application Priority Data
Mar. 22, 2018 (IN) 201811010564

(51) Int. Cl. G06Q 10/04; B65G 1/137; G06Q 10/08; G06Q 30/06

(52) U.S. Cl. CPC G06Q 10/047; G06Q 30/0603; G06Q 10/087; B65G 1/1373

(57) ABSTRACT

A system and a method for the continuous pick route optimization in an order fulfillment system is discussed. The system receives inputs to the one or more orders from the database based on operations and stores the inputs in a local input cache. The system determines a delta in the local input cache based on the inputs and selects an optimization algorithm from a set of optimization algorithms based at least in part on the delta passing a threshold. The system executes the optimization algorithm on the one or more orders resulting in an optimized picklist and compares the optimized picklist against a cached picklist stored in a commit cache. The optimized picklist is stored to a result cache. The system receives a request for a picklist from a mobile electronic device and sends the optimized picklist to the mobile electronic device.

### RELATED APPLICATIONS

This application claims priority to Indian Patent Application No. 201811010564 entitled “SYSTEM AND METHOD FOR CONTINUOUS PICK ROUTE OPTIMIZATION,” filed on Mar. 22, 2018, the content of which is hereby incorporated by reference in its entirety.

### BACKGROUND

Online orders received by a global order fulfillment system often require picking items in a store, distribution center or warehouse. The fulfillment system determines pick routes for the items in the order. The pick routes are executed by workers in a facility.

### BRIEF DESCRIPTION OF DRAWINGS

Illustrative embodiments are shown by way of example in the accompanying drawings and should not be considered as a limitation of the present disclosure:

FIG. 1 is a block diagram illustrating a system for receiving and processing of orders in a global order fulfillment system according to an exemplary embodiment.

FIG. 2 is flow diagram illustrating a system for the continuous pick route optimization in a global order fulfillment system according to an exemplary embodiment.

FIG. 3 is a flowchart illustrating a process for the continuous pick route optimization in a global order fulfillment system according to an exemplary embodiment.

FIG. 4 is a block diagram illustrating an electronic device for the continuous pick route optimization in a global order fulfillment system according to an exemplary embodiment.

### DETAILED DESCRIPTION

Described in detail herein is a system for the continuous pick route optimization in a global order fulfillment system. In one embodiment, the fulfillment system receives an order input. The order input is stored in an order database. Additionally, data associated with the order such as metadata is stored in a distributed in-memory cache for faster access. The order input data in the distributed in-memory cache may be examined by an optimization module to determine an amount of change in the contents of the orders. If the amount of change meets a threshold, the optimization of a pick route used to fulfill the order is triggered. An algorithm may be selected from a group of algorithms for optimizing the pick route. The algorithm is executed to determine a new pick route that includes the new input and the previously existing orders. The system compares the new pick route against the pre-existing pick route to determine a change in efficiency. If the new pick route meets a second threshold, the new pick route is saved to a commit cache. When a worker requests a pick route for order fulfillment the system provides the pick route in the commit cache and updates the order database to indicate that order is being fulfilled.

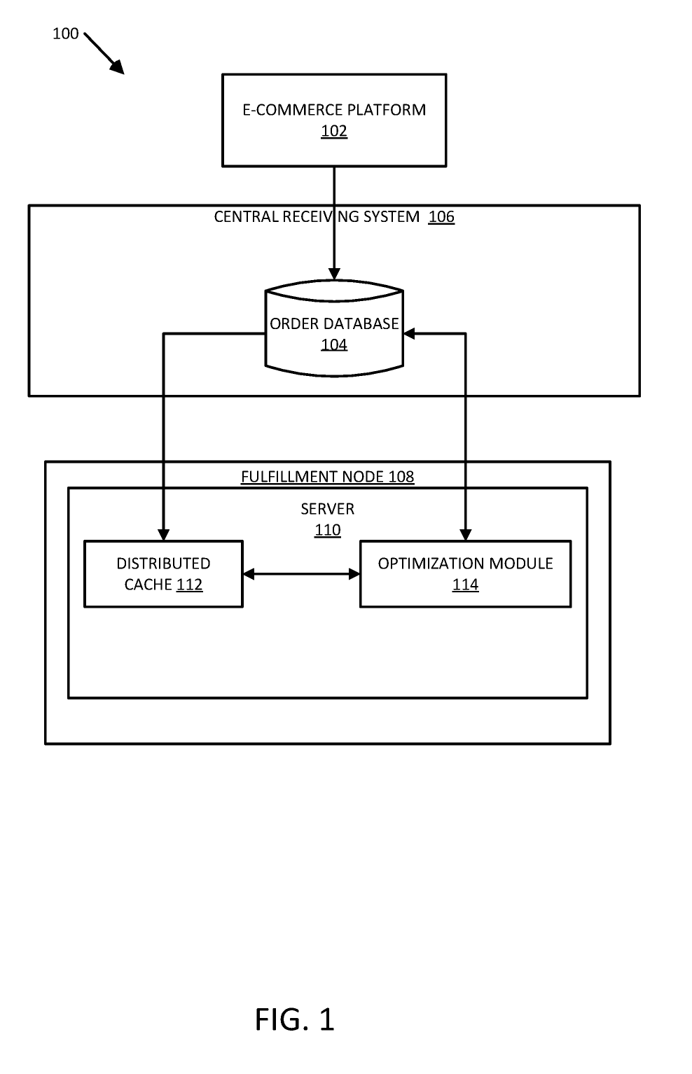

FIG. 1 is a block diagram 100 illustrating a system for receiving and processing of orders in a global order fulfillment system according to an exemplary embodiment.

As depicted in FIG. 1, the entry point into the system may start with an e-commerce platform 102. The e-commerce platform 102 may be a system that is designed to present an online customer-facing ordering interface. The e-commerce platform 102 may include separate frontend and backend components for processing different stages in the ordering process. For example, the frontend may include multiple customer-facing ordering interfaces, including websites, mobile applications designed to execute on mobile platforms such as the Android operating system, the iOS operating system, or as an extension or applet in a browser-based environment such as Chrome in the ChromeOS operating system environment. The backend may include the support structure to provide the customer-facing ordering interfaces with data relating to orderable products including but not limited to product images, product details, product availability and product pricing. Additionally, the backend may include the support for receiving and storing any submitted order from the customer-facing ordering interfaces. The e-commerce platform 102 may utilize a local area network (LAN), a wide area network (WAN) or the internet.

The e-commerce platform 102 interfaces with an integrated fulfillment system for an organization. The integrated fulfillment system provides the support structure for order fulfillment across the organization. The integrated fulfillment system may include multiple computing systems, both physical and virtualized, supporting networking systems to communicatively connect the multiple computing systems and storage systems for cataloging products, orders, and other information relevant for receiving and processing customer orders. The integrated fulfillment system may also include software that facilitates the receiving and fulfillment of orders. The integrated fulfillment system includes a central receiving system 106 and one or more integrated fulfillment nodes 108.

The central receiving system 106 is the central receiving system for orders into the integrated fulfillment system. The central receiving system 106 may be physically located or virtually associated with the headquarters of an organization. Multiple systems including the order fulfillment systems may be incorporated into the central receiving system 106. The central receiving system 106 may include an order database 104. The order database 104 may incorporate one or more databases with a common application programming interface (API) for accessing the contents, thereby abstracting the one or more database implementation from external applications utilizing the database. The order database 104 may provide interfaces for inserting new orders, updating existing orders, completing orders, deleting or cancelling orders, and archiving orders.

As the order database 104 includes a standardized API, different subsystems may interface with it. For example, integrated fulfillment nodes 108 interface with the order database 104. The integrated fulfillment nodes 108 are sites with the capability for fulfilling the orders. In some embodiments, the integrated fulfillment nodes 108 may correspond to a store, warehouse or distribution center. Alternatively, the integrated fulfillment nodes 108 may correspond to a region or market of the organization, and services stores, warehouses, and distribution centers in that region or market. Integrated fulfillment nodes 108 may each include a server 110. The server 110 may be physical or virtualized. The server 110 may be communicatively networked with the order database 104. The server 110 may be operable to interface with the order database 104 utilizing an API described above.

The server 110 executes optimization module 114 and provides distributed (in-memory) cache 112. Distributed cache 112 receives the order inputs from the e-commerce platform 102. Optimizer module 114 receives orders from the order database 104. Optimizer module 114 may be a multi-instance application in which a single instance corresponds to a store, warehouse or distribution center to fulfill an order. Alternatively, the optimizer module 114 may be a single instance application with multiple worker threads, where each thread corresponds to a store, warehouse or distribution center to fulfill an order. Distributed cache may be located on multiple servers. The optimizer module 114 interfaces with the distributed cache 112 through an API to identify whether the new input order information meets a threshold such that a new pick list calculation should be attempted. Inputs to the optimizer module 114 may include existing orders and the order inputs received from the e-commerce platform 102. Outputs from the optimizer module 114 may include optimized pick routes.

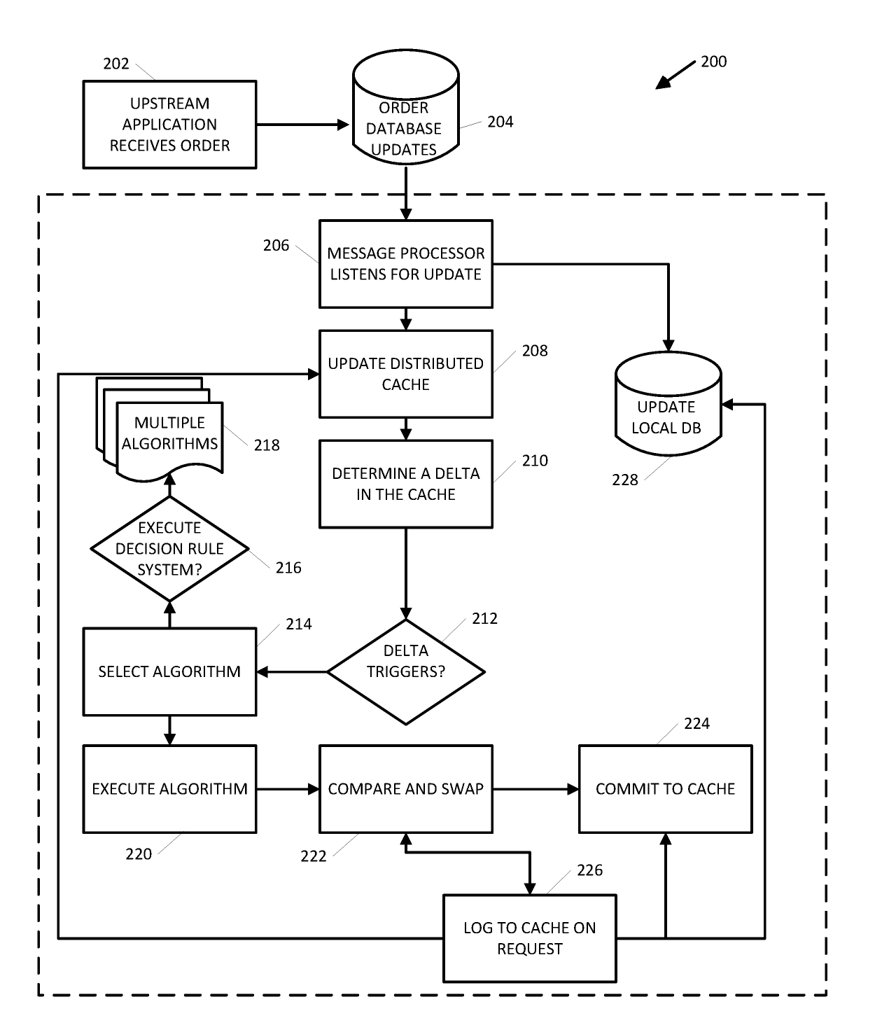

FIG. 2 is flow diagram 200 illustrating a system for the continuous pick route optimization in an order fulfillment system according to an exemplary embodiment.

At step 202 an upstream application receives an order and order inputs to a database. The upstream application may be implemented as part of the e-commerce platform 102. At step 204 the order database 104 updates a record of the changes in the orders as well as the creation of new orders.

At step 206 a message processor listens for an update in the database. The message processor binds to the order database 104 and monitors for change events in the tables corresponding to orders. The message processor in one embodiment may be implemented as a Java Message Service (JMS) listener object. When a change in the order database 104 occurs, an event is generated notifying the message processor. The message processor updates a local database at step 228 and updates the distributed cache 112 at step 208, both updates containing the details of the change observed in the order database 104.

The distributed cache 112 provides localized storage for the order database 104 events as reported by the message processor 206. The distributed cache 112 provides increased efficiency as it eliminates unnecessary queries into the order database 104. Order calculations may be performed locally out of the distributed cache 112 rather than interfacing with the order database 104. In one embodiment, the distributed cache 112 may be implemented as a data structure residing in memory. The data structure may provide accessor functions to interface with each entry in the distributed cache 112. More complex operations may be included as an API for the distributed cache 112. When implemented in memory (RAM), the distributed cache 112 provides faster data access than querying the order database 104, thereby accelerating the pick route optimization process and lessening the burden on the order database 104.

Optimization module 114 may include a smart delta sensor and trigger to determine a delta in the cache at step 210. The smart delta sensor and trigger is an executable process that monitors changes in the distributed cache 112 pertaining to each input related to an order. The smart delta sensor and trigger evaluates changes in an order or monitors new incoming orders. Based on the change of an order, the smart delta sensor and trigger measure the amount of change in an order. The smart delta sensor and trigger may measure order details differently. For example, a change in order due time may indicate a more impactful change to the order and thereby the weight for that change may be greater than an allowed threshold. Changes can include the receipt of a new order, order cancellation, partial order cancellation, item location change, item type change, and store pick worker logout. For every change, the smart delta sensor and trigger may input/increment the change based on a weight assigned to the change. The incremented change is measured against the specific threshold.

If the change meets a threshold an event is triggered. There are multiple thresholds for every item being ordered. The item thresholds are selected to enable item picking in the stores. The thresholds are different for different commodities based on the typical number of order items per order and the number of store workers picking per item. Upon the meeting of a threshold, at step 212, the delta triggers the selection of the algorithm.

Upon the trigger event at step 212, the selection algorithm at step 214 may be executed. The selection may factor across all stores, warehouses, and distribution centers within an organization. Each store, warehouse, and distribution center within an organization may have a localized order volume and download pattern. One algorithm may work well for one store, but not for a warehouse. The selection may execute a decision rule system, at step 216, to select from a set of multiple algorithms 218 which feed input criteria like priority codes, fulfillment types, dispense times and order volume categories. The execution of the decision rule system at step 216 may determine that order volume category may play a key role in determining the threshold values set for a particular store. The stores which have high order volume may have higher thresholds to make sure the algorithm is not started too frequently and thereby stress the system.

The categorization of stores into high/medium/low volume stores may be an automatic process. The stores may start with a medium category and static volume of high/medium/low volume seeded data. The stores may then move to an appropriate category over a number of days depending on the average order volume at the store. The set of multiple algorithms 218 may include algorithms to emphasize one aspect over another. For example, one algorithm may emphasize shortest path algorithm and another may emphasize maximum number of items. Additionally, the optimization algorithm may be selected based on the number of store workers available to fulfill a picklist

Once the algorithm is selected, the algorithm is executed at step 220 where the algorithm is applied to the updated order list and configuration. To further demonstrate the optimization module described herein reference is made to the results of a conventional pick route algorithm A configuration (C1) (see Table 1) may be utilized as a constraint for the algorithm.

TABLE 1

Configuration = C1
Max orders in a picklist = 4
Max due time difference in
a picklist = 120 minutes

TABLE 2

| | | Order |
|---|---|---|
| Customer | Order | download |
| order ID | due time | time |
| 1 | 7:00 | 1:00 |
| 2 | 8:30 | 1:15 |
| 3 | 8:00 | 1:15 |
| 4 | 10:00 | 1:30 |
| 5 | 12:00 | 1:30 |
| 6 | 12:00 | 1:30 |
| 7 | 13:00 | 1:30 |
| 8 | 7:15 | 1:30 |
| 9 | 7:30 | 2:00 |
| 10 | 8:15 | 2:00 |

In the instance where no optimization is applied, picklists generated at 1:35 (Table 3) and 2:05 (Table 4) will be generated.

TABLE 3

| | | | | |
|---|---|---|---|---|
| P1 | 1 | 8 | 3 | 2 |
| P2 | 4 | 5 | 6 | |
| P3 | 7 | | | |

TABLE 4

| | | | | |
|---|---|---|---|---|
| P1 | 1 | 8 | 3 | 2 |
| P2 | 9 | 10 | | |
| P3 | 4 | 5 | 6 | |
| P4 | | | | |

As demonstrated, these non-optimized picklists generated at 2:05 (Table 4) have less than four orders as specified by the configuration C1. However, the picklists in Table 4 are not as efficient as they do not utilize trips to their fullest. Order number nine may be grouped with orders 1, 8, 3 because it is due earlier than other orders. The grouping did not happen because the non-optimized algorithm did not re-optimize the picklists/routes generated at 1:35.

In contrast, utilizing an optimized algorithm, the picklists at 1:35 (Table 3) and the new picklists of 2:05 (Table 5) demonstrate more efficient distributions.

TABLE 5

| | | | | |
|---|---|---|---|---|
| P1 | 1 | 8 | 9 | 3 |
| P2 | 10 | 2 | 4 | |
| P3 | 5 | 6 | 7 | |

The number of picklists may be reduced from four to three and the picklists are more efficiently filled as compared to the picklists in Table 4. Order number nine may be properly grouped with the orders one, eight, and three. The algorithm may also discard or hold picklists P2 and P3 as they are not filled to optimum capacity. Additionally, the optimized picklist may be based on time ordered, time due, and the size of the delta detected by the smart delta sensor and trigger.

The output of the executed algorithm may be processed by the compared and swapped at step 222. The comparison includes analyzing the output with the picklists already served (from the Commit Log Cache 224) to store workers. The comparing process may then decide whether to withhold and discard inefficient picklists rather than releasing. The decision is made on the basis of multiple scenarios like the number of orders available, number of picklists available, and number of store workers available to pick a picklist.

The refined output from the comparison may be swapped and committed to the cache at step 224. The committed cache 226 may be stored in the same distributed in-memory cache cluster as the distributed cache 112. No database operation takes place in this transfer. The process continues upon changes occurring in the distributed cache 112, where no database 228 interfaces take place, thereby utilizing faster caches over expensive database accesses to more efficiently execute the process.

Upon the request for a picklist for processing by a worker, the system retrieves the picklist with the highest priority, logs it to the cache at step 226, provides it to the worker, and records the request and the picklist in both the cache, and in the database 228, since the picklist is in work.

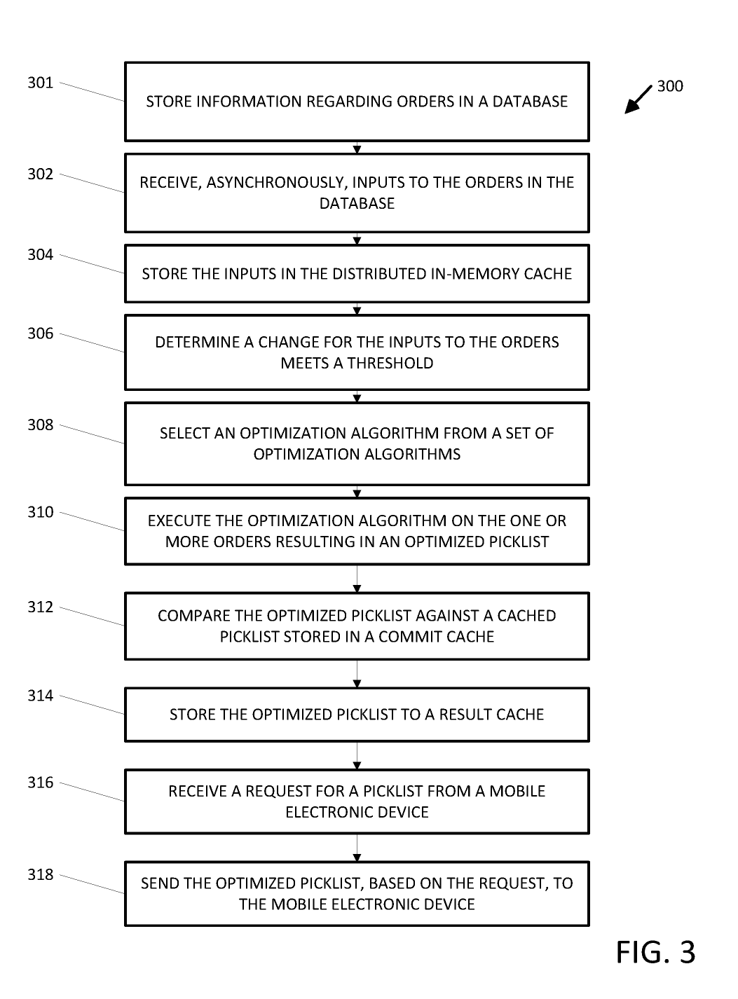

FIG. 3 is a flowchart illustrating a process for the continuous pick route optimization in an order fulfillment system according to an exemplary embodiment.

At step 301, an e-commerce platform 102, stores information regarding operations for a plurality of orders in a database. The information may be new orders, updates to orders, and cancellations of orders.

At step 302 the optimizer module 114 receives, asynchronously, inputs to the one or more orders from the database based on the operations. As described above, the message processor 206 listens for changes in an order database 104. The input changes may include updates to an order, cancelations of orders, partial cancelations of orders, and new orders.

At step 304, the optimizer module 114 stores the inputs in a local input cache. The local input cache may take the form of the distributed cache 112 as described above. The local input cache provides an implementation for locally storing the changes without having to access the order database 104 and increase stresses on that part of the system.

At step 306, the optimizer module 114 determines a delta in the local input cache, wherein the delta comprises a change incurred during the input in the one or more orders. In one embodiment, the delta may be determined by the smart delta sensor and trigger 210 as described above. The trigger 212 event occurs when the smart delta sensor and trigger 210 detect that a weighted change in an order crosses a threshold.

At step 308, the optimizer module 114 selects an optimization algorithm from a set of optimization algorithms based at least in part on the delta passing a threshold. As described above the decisions rule system 216 may select an optimization algorithm from the set of multiple algorithms 218 depending on criteria regarding the store where the pick will be executed.

At step 310, the optimizer module 114 executes the optimization algorithm on the one or more orders resulting in an optimized picklist.

At step 312, the optimizer module 114 compares the optimized picklist against a cached picklist stored in a commit log cache. The comparing may be based on the number of orders, number of picklists in the commit cache, and a number of workers available to fulfill a picklist.

At step 314, the optimizer module 114 stores the optimized picklist to a result cache. In one embodiment, the result cache may take the form of the result log cache 226 to hold optimized picklists until request from a worker for fulfillment.

At step 316, the optimizer module 114 receives a request for a picklist from a mobile electronic device. The optimizer module 114 may hold optimized picklists in queue, even after receiving a requires for the picklist, wherein the optimized picklist contains items not meeting a picklist threshold of items. For example, the configuration C1 (see Table 1) includes a maximum number of items and an optimized picklist for release may contain the maximum number of items.

At step 318, the optimizer module 114 sends the optimized picklist, based on the request, to the mobile electronic device. The mobile device may present the store worker with a graphical user interface indicating the next item in to be picked from the picklist. The mobile electronic device may also include directions for navigating the store, warehouse or distribution center.

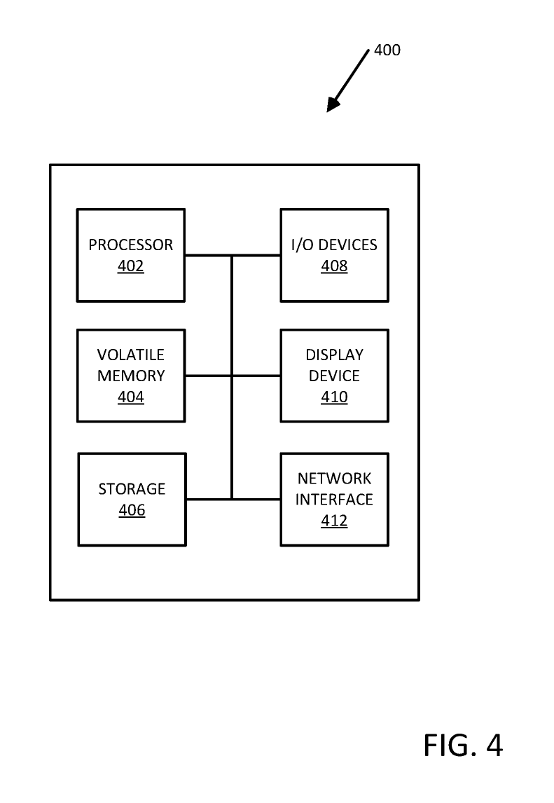

FIG. 4 is a block diagram illustrating an electronic device for the continuous pick route optimization in an order fulfillment system according to an exemplary embodiment.

A computing device 400 supports the continuous pick route optimization in an order fulfillment system. The computing device 400 can embody the server 110 on which the optimizer module 114 can execute. The computing device 400 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 404 included in the computing device 400 can store computer-readable and computer-executable instructions or software for implementing exemplary operations of the computing device 400. The computing device 400 also includes configurable and/or programmable processor 402 for executing computer-readable and computer-executable instructions or software stored in the volatile memory 404 and other programs for implementing exemplary embodiments of the present disclosure. Processor 402 can be a single core processor or a multiple core processor. Processor 402 can be configured to execute one or more of the instructions described in connection with computing device 400.

Volatile memory 404 can include a computer system memory or random access memory, such as DRAM, SRAM, EDO RAM, and the like. Volatile memory 404 can include other types of memory as well, or combinations thereof.

A user can interact with the computing device 400 through a display 410, such as a computer monitor, which can display one or more graphical user interfaces supplemented by I/O devices 408, which can include a multi-touch interface, a pointing device, an image capturing device and a reader.

The computing device 400 can also include storage 406, such as a hard-drive, CD-ROM, or other computer-readable media, for storing data and computer-readable instructions and/or software that implement exemplary embodiments of the present disclosure (e.g., applications). For example, storage 406 can include one or more storage mechanisms for storing information associated with the order information and the generated picklists.

The computing device 400 can include a network interface 412 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 412 can include one or more antennas to facilitate wireless communication between the computing device 400 and a network and/or between the computing device 400 and other computing devices. The network interface 412 can include a built-in network adapter, network interface card, PCMCIA network card, card bus network adapter, wireless network adapter, USB network adapter, modem or any other device suitable for interfacing the computing device 400 to any type of network capable of communication and performing the operations described herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step. Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A system for the continuous optimization of pick routes comprising:
a database, configured to store information regarding operations for a plurality of orders;
a distributed in-memory cache holding information about the plurality of orders;
a server communicatively coupled to the database and configured to execute an optimization module that when executed:
receives, asynchronously from a plurality of sources, a plurality of inputs to the plurality of orders,
stores the inputs in the distributed in-memory cache and the database,
determines, using the information in the distributed in-memory cache, that at least one of the inputs to the plurality of orders represents a change that meets a threshold,
selects an optimization algorithm from a set of optimization algorithms based at least in part on the change meeting the threshold,
executes the optimization algorithm on the plurality of orders using the information in the distributed in-memory cache, the executing resulting in an optimized picklist,
compares the optimized picklist against a cached picklist stored in a commit cache,
stores the optimized picklist to a result cache,
receives a request for a picklist from a mobile electronic device associated with a worker in a facility,
sends the optimized picklist, based on the request, to the mobile electronic device.

2. The system of claim 1, wherein the set of optimization algorithms comprises a shortest path algorithm and a maximum number of items algorithm.

3. The system of claim 1, wherein the optimization algorithm is selected from a set of optimization algorithms based at least in part on a number of workers available to fulfill a picklist.

4. The system of claim 1, wherein the optimized picklist is based on a time ordered, a time due, and a change in the number of items.

5. The system of claim 1, wherein the operations include updating an order, creating a new order, cancelling an order.

6. The system of claim 1, wherein an optimized picklist not meeting a threshold of items is held in queue, responsive to receiving a request for the picklist.

7. The system of claim 1, wherein the comparing is based on the number of orders, number of picklists in the commit cache, and a number of workers available to fulfill a picklist.

8. A method for the continuous optimization of pick routes comprising:
storing information regarding operations for a plurality of orders in a database;
receiving, asynchronously from a plurality of sources, inputs to the operations for the plurality of orders,
storing the inputs in the database and a distributed in-memory cache,
determining, using the information in the distributed in-memory cache, that at least one of the inputs to the plurality of orders represents a change that meets a threshold,
selecting an optimization algorithm from a set of optimization algorithms based at least in part on the change meeting the threshold,
executing the optimization algorithm on the plurality of orders using the information in the distributed in-memory cache, the executing resulting in an optimized picklist,
comparing the optimized picklist against a cached picklist stored in a commit cache,
storing the optimized picklist to a result cache,
receiving a request for a picklist from a mobile electronic device associated with a worker in a facility,
sending the optimized picklist, based on the request, to the mobile electronic device.

9. The method of claim 8, wherein the set of optimization algorithms comprises a shortest path algorithm and a maximum number of items algorithm.

10. The method of claim 8, wherein the optimization algorithm is selected from a set of optimization algorithms based at least in part on the number of workers available to fulfil a picklist.

11. The method of claim 8, wherein the optimized picklist is based on a time ordered, a time due, and a change in the number of items.

12. The method of claim 8, wherein the operations include updating an order, creating a new order, cancelling an order.

13. The method of claim 8, wherein an optimized picklist not meeting a threshold of items is held in queue, responsive to receiving a request for the picklist.

14. The method of claim 8, wherein the comparing is based on a number of orders, a number of picklists in the commit cache, and a number of workers available to fulfill a picklist.

15. A non-transitory computer-readable medium for the continuous optimization of pick routes, having stored thereon, instructions that when executed in a computing system, cause the computing system to perform operations comprising:
storing information regarding operations for a plurality of orders in a database;
receiving, asynchronously from plurality of sources, inputs to the operations for the plurality of orders,
storing the inputs in the database and a distributed in-memory cache,
determining, using the information in the distributed in-memory cache, that at least one of the inputs to the plurality of orders represents a change that meets a threshold,
selecting an optimization algorithm from a set of optimization algorithms based at least in part on the change meeting the threshold,
executing the optimization algorithm on the plurality of orders using the information in the distributed in-memory cache, the executing resulting in an optimized picklist,
comparing the optimized picklist against a cached picklist stored in a commit cache,
storing the optimized picklist to a result cache,
receiving a request for a picklist from a mobile electronic device associated with a worker in a facility,
sending the optimized picklist, based on the request, to the mobile electronic device.

16. The computer-readable medium of claim 15, wherein the set of optimization algorithms comprises a shortest path algorithm and a maximum number of items algorithm.

17. The computer-readable medium of claim 15, wherein the optimization algorithm is selected from a set of optimization algorithms based at least in part on the number of workers available to fulfil a picklist.

18. The computer-readable medium of claim 15, wherein the optimized picklist is based on a time ordered, a time due, and a change in the number of items.

19. The computer-readable medium of claim 15, wherein the operations include updating an order, creating a new order, cancelling an order.

20. The computer-readable medium of claim 15, wherein the instructions for comparing is based on a number of orders, a number of picklists in the commit cache, and a number of workers available to fulfill a picklist.
